(19) United States
(12) Patent Application Publication
(10) Pub. No.: US 2020/0378583 A1
(43) Pub. Date: Dec. 3, 2020

(54) MULTIPURPOSE BRACKET

(71) Applicant: Amline Products Ltd., Taipei City (TW)

(72) Inventors: Shu-Hsiang CHENG, Taipei City (TW); Jie-Yuan CHANG, Taipei City (TW)

(21) Appl. No.: 16/426,062

(22) Filed: May 30, 2019

(51) Int. Cl. F21V 21/08

(52) U.S. Cl. CPC F21V 21/08

(57) ABSTRACT

There is provided a multipurpose bracket including a horizontal portion, a right vertical portion, and a left vertical portion. The horizontal portion has a hook on a front surface of the horizontal portion, and a downward protrusion at a lower edge of the horizontal portion. The right vertical portion is connected at a right end of the horizontal portion, and has a right-upper protrusion and a right-lower protrusion. The left vertical portion is connected at a left end of the horizontal portion, and has a left-upper protrusion and a left-lower protrusion.

### BACKGROUND OF THE INVENTION

### 1. Field of the Invention

The present invention relates to a multipurpose bracket that can be coupled with various types of springs, particularly, in applications of lamp assembly.

### 2. Description of Related Art

There are various types of light fixtures (also called light fittings or luminaires) that may be mounted into ceilings, grounds, walls, or decors to provide downlight, uplight, sidelight (such as wall wash, wall light, and so on), or light for other directions. For example, the downlight is the light fixture mounted into the ceiling. The downlight typically includes a housing hidden in the ceiling, a trim visible on the ceiling, and a lamp arranged between the housing and the trim. A selection of housings will narrow down options of lamps available for the selected housing.

FIG. 1A shows a schematic diagram of a prior art lamp assembly 1. The lamp assembly 1 includes a lamp housing 12, a lamp body 14, and two spring clips 16. The lamp housing 12 is arranged and typically fixed in an opening 102 of a ceiling 10. Each spring clip 16 has one end 162 fastened to the lamp body 14, and another end 164 abutted on a wall of the lamp housing 12. The lamp body 14 is attached to the lamp housing 12 through spring forces exerted by the two spring clips 16.

FIG. 1B shows an exploded view of the lamp body 14 and the spring clip 16 in the prior art lamp assembly 1 in FIG. 1. As shown in FIG. 1B, a notch portion 142 is formed in the lamp body 14, and the notch portion 142 is designed to have a special shape that fits the end 162 of the spring clip 16 so that the spring clip 16 can be fastened to the lamp body 14.

However, in the prior art lamp assembly 1, one disadvantage is that an additional manufacturing process is necessary to form the notch portion 142 on the lamp body 14. Another disadvantage is that the special shape of the notch portion 142 limits the lamp body 14 to a specific type of spring clip 16. Other types of spring clip 16 cannot be used in the lamp body 14.

FIGS. 2A and 2B show a schematic diagram of another prior art lamp assembly 1′, particularly with a more recently used lamp body 14′ different from the lamp body 14 shown in FIGS. 1A and 1B. Except for the lamp body 14′, the components and the structures shown in FIGS. 2A and 2B are similar to those shown in FIGS. 1A and 1B.

Recently, houses have modular constructions of ceiling or wall. Various lamp housings embedded in various modular ceilings or walls may employ their specific springs, depending on their shapes, sizes, or positions. A customer may hope that a lamp body can be engaged with various types of springs, and thus can be attached into various types of lamp housings, so that the lamp body can be easily installed from one room to another room, or from one house to another house.

Therefore, it is desirable to provide a multipurpose bracket to realize such requirement.

### SUMMARY OF THE INVENTION

According to one aspect of the present invention, there is provided a multipurpose bracket including a horizontal portion, a right vertical portion, and a left vertical portion. The horizontal portion has a hook on a front surface of the horizontal portion, and a downward protrusion at a lower edge of the horizontal portion. The right vertical portion is connected at a right end of the horizontal portion, and has a right-upper protrusion and a right-lower protrusion. The left vertical portion is connected at a left end of the horizontal portion, and has a left-upper protrusion and a left-lower protrusion.

Optionally or preferably, the multipurpose bracket may further include an insert connected at an upper edge of the horizontal portion.

Optionally or preferably, the insert may be bended toward a back surface of the horizontal portion.

Optionally or preferably, the horizontal portion, the right vertical portion, the left vertical portion, and the insert may be formed integrally.

Optionally or preferably, the horizontal portion may have a symmetric shape, and the right vertical portion may be symmetric to the left vertical portion.

Optionally or preferably, the multipurpose bracket may further include an upper opening and a lower opening. The upper opening is defined by the lower edge of the horizontal portion, the right-upper protrusion of the right vertical portion, and the left-upper protrusion of the left vertical portion. The lower opening is defined by the right-upper protrusion and right-lower protrusion of the right vertical portion, and the left-upper protrusion and the left-lower protrusion of the left vertical portion. The upper opening may be continuous with the lower opening.

Optionally or preferably, the upper opening and the lower opening may have different shapes.

Optionally or preferably, the downward protrusion of the horizontal portion and the upper opening may be adapted to be coupled with a leaf spring.

Optionally or preferably, the right-upper protrusion of the right vertical portion may face toward the left-upper protrusion of the left vertical portion, and they may be adapted to be coupled with a torsion spring.

Optionally or preferably, the hook of the horizontal portion may be adapted to be coupled with a clip spring.

According to another aspect of the present invention, there is provided a multipurpose bracket including an upper horizontal portion, a right vertical portion, a left vertical portion, and a lower horizontal portion. The upper horizontal portion has a downward protrusion at a lower edge of the upper horizontal portion. The right vertical portion is connected at a right end of the horizontal portion, and has a right protrusion. The left vertical portion is connected at a left end of the horizontal portion, and has a left protrusion. The lower horizontal portion is connected with the right vertical portion and the left vertical portion, and has a hook on a front surface of the lower horizontal portion.

Optionally or preferably, the multipurpose bracket may further include an insert connected at an upper edge of the upper horizontal portion.

Optionally or preferably, the insert may be bended toward a back surface of the upper horizontal portion.

Optionally or preferably, the upper horizontal portion, the right vertical portion, the left vertical portion, the lower horizontal portion, and the insert may be formed integrally.

Optionally or preferably, the upper horizontal portion may have a symmetric shape, and the right vertical portion may be symmetric to the left vertical portion.

Optionally or preferably, the multipurpose bracket may further include an upper opening and a lower opening. The upper opening is defined by the lower edge of the upper horizontal portion, the right protrusion of the right vertical portion, and the left protrusion of the left vertical portion. The lower opening is defined by the right protrusion of the right vertical portion, the left protrusion of the left vertical portion, and an upper edge of the lower horizontal portion. The upper opening may be continuous with the lower opening.

Optionally or preferably, the upper opening and the lower opening may have different shapes.

Optionally or preferably, the upper protrusion of the upper horizontal portion and the upper opening may be adapted to be coupled with a leaf spring.

Optionally or preferably, the right protrusion of the right vertical portion may face toward the left protrusion of the left vertical portion, and they may be adapted to be coupled with a torsion spring.

Optionally or preferably, the hook of the lower horizontal portion may be adapted to be coupled with a clip spring.

It is to be understood that the multipurpose bracket of the present invention has a special structure that can be coupled with various types of springs. The multipurpose bracket of the present invention can be an intermediate connector for a spring arranged between a lamp and a lamp housing.

Using the multipurpose bracket of the present invention, a customer does not have to buy a specific lamp to fit a spring of a specific lamp housing, and the customer can have more choices when purchasing a lamp. This makes life more convenient.

Moreover, the multipurpose bracket of the present invention allows a lamp to be reused from one lamp housing to another lamp house. The lamp will not be discarded because of the problem of incompatibility, and this improves environmental protection.

Furthermore, lamp assembling using the multipurpose bracket of the present invention can be done by the customer rather than a technician. A “Do It Yourself” (DIY) lamp assembly can be realized.

Other objects, novel features, and advantages of the present invention will become more apparent from the following detailed description when taken in conjunction with the accompanying drawings.

### BRIEF DESCRIPTION OF THE DRAWINGS

FIG. 1A shows a schematic diagram of a prior art lamp assembly;

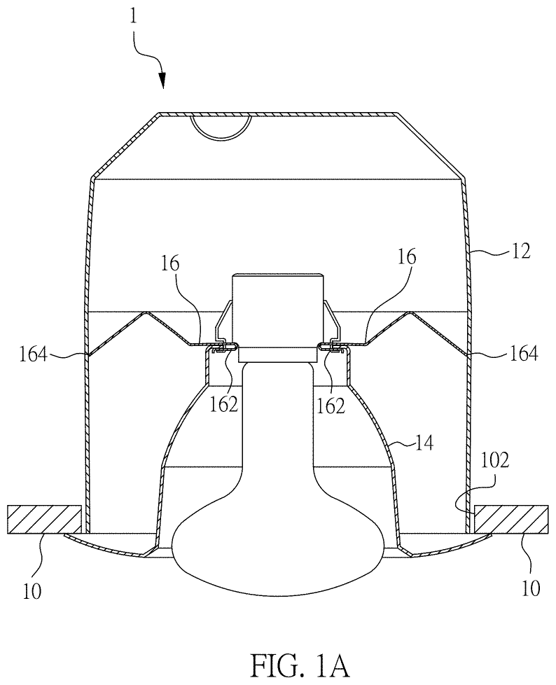

FIG. 1B shows an exploded view of the lamp body and the spring clip in the prior art lamp assembly in FIG. 1A;

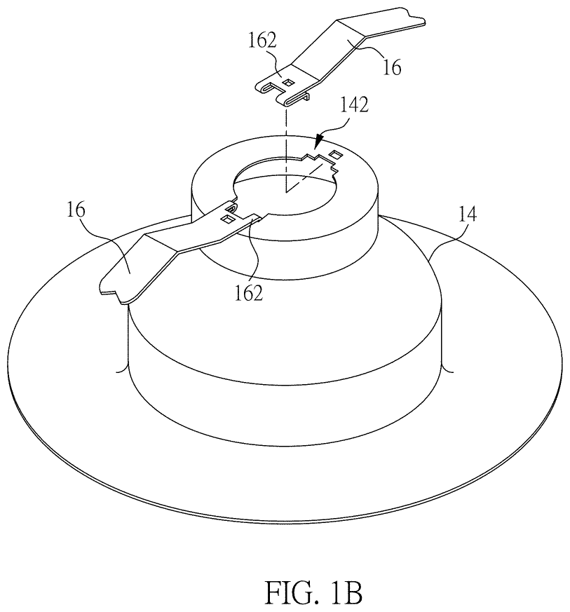

FIGS. 2A and 2B show a schematic diagram of another prior art lamp assembly;

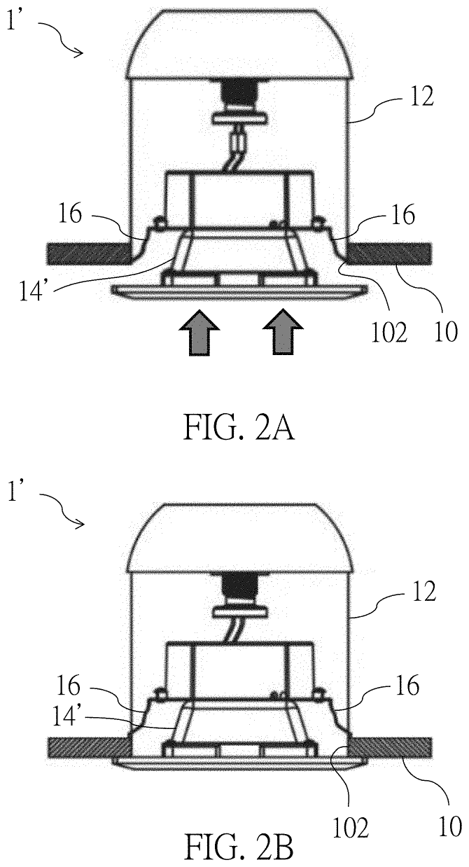

FIG. 3 shows a schematic diagram of the multipurpose bracket when attached to a lamp body according to one embodiment of the present invention;

FIGS. 4A, 4B, and 4C respectively show a perspective view, a front view, and a side view of the multipurpose bracket according to one embodiment of the present invention;

FIGS. 5A, 5B, and 5C respectively show a perspective view, a front view, and a side view of the multipurpose bracket coupled with a first type of spring according to one embodiment of the present invention;

FIGS. 6A and 6B respectively show a perspective view and a front view of the multipurpose bracket coupled with a second type of spring according to one embodiment of the present invention;

FIGS. 7A and 7B respectively show a perspective view and a front view of the multipurpose bracket coupled with a third type of spring according to one embodiment of the present invention;

FIGS. 8A, 8B, 8C, and 8D respectively show a perspective view, a front view, a back view, and a side view of the multipurpose bracket according to one embodiment of the present invention; and

FIG. 9 shows a front view of the multipurpose bracket coupled with a clip spring according to one embodiment of the present invention.

### DETAILED DESCRIPTION OF THE EMBODIMENT

Different embodiments are provided in the following description. These embodiments are used to explain the technical contents of the present invention, but not meant to limit the scope of the claimed inventions. One feature in one embodiment may be applied to other embodiments by suitable modification, substitution, combination, and/or separation according to this description.

It is noted that, in this description, the terms about direction or orientation, such as “up”, “down”, “left”, “right”, “front”, “back”, and so on, are used to express spatial relations between a plurality of elements. Cases of reflections and/or rotations should be included in interpretations of these terms.

Ordinal numbers, such as “first”, “second”, and so on, are used to distinguish a plurality of elements having the same name, and it does not necessarily mean that an order, a level, an executing sequence, or a manufacturing sequence exists among them. Moreover, a “first” element and a “second” may exist together in one component, or separately in different components.

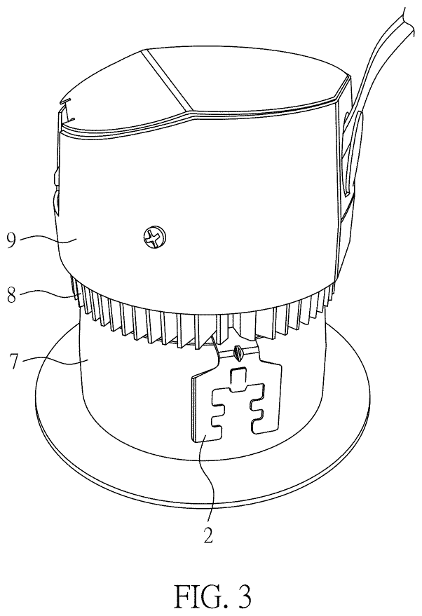

FIG. 3 shows a schematic diagram of the multipurpose bracket 2 when attached to a lamp body 7 according to one embodiment of the present invention.

As shown in FIG. 3, the multipurpose bracket 2 of the present invention may be easily attached to the lamp body 7 by inserting it into a gap between the lamp body 7 and a heat sink 8 of a lamp socket 9.

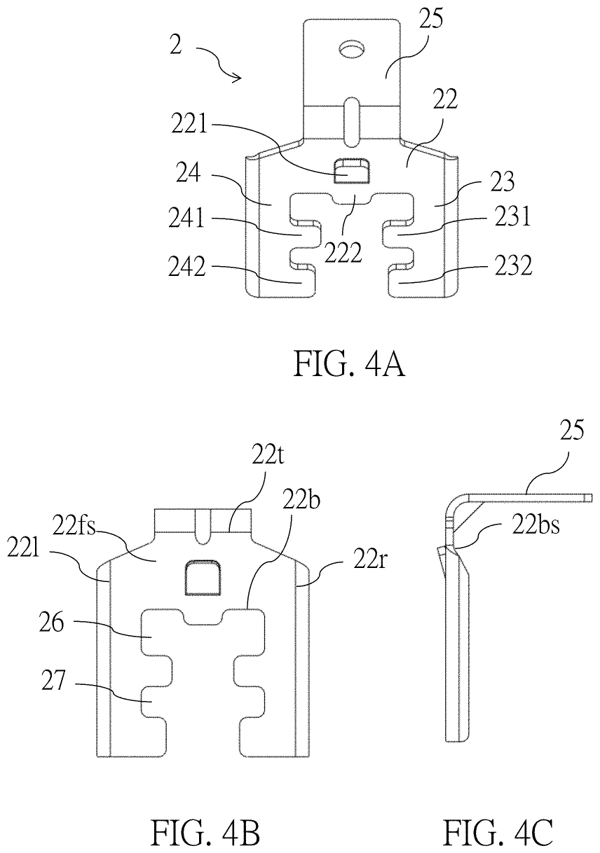

FIGS. 4A, 4B, and 4C respectively show a perspective view, a front view, and a side view of the multipurpose bracket 2 according to one embodiment of the present invention.

Referring together to FIGS. 4A, 4B, and 4C, the multipurpose bracket 2 includes a horizontal portion 22, a right vertical portion 23, and a left vertical portion 24.

The horizontal portion 22 has a hook 221 on a front surface 22fs of the horizontal portion 22, and a downward protrusion 222 at a lower edge 22b of the horizontal portion 22.

The right vertical portion 23 is connected at a right end 22r of the horizontal portion 22, and has a right-upper protrusion 231 and a right-lower protrusion 232.

The left vertical portion 24 is connected at a left end 221 of the horizontal portion 22, and has a left-upper protrusion 241 and a left-lower protrusion 242.

The multipurpose bracket 2 may be attached to the lamp body 7 shown in FIG. 3 in any suitable way, such as an adhesive or a fastener. However, for more convenience, the multipurpose bracket 2 may include an insert 25 connected at an upper edge 22t of the horizontal portion 22. Moreover, the insert 25 may be bended toward a back surface 22bs of the horizontal portion 22, so that the multipurpose bracket 2 may be inserted into a gap between the lamp body 7 and another device.

Preferably, the horizontal portion 22, the right vertical portion 23, the left vertical portion 24, and the insert 25 may be formed integrally, by casting, forging, stamping, or any other suitable metalworking, so that the multipurpose bracket 2 may have a stronger structure.

As shown in FIG. 4A, the multipurpose bracket 2 is symmetric along a symmetric axis (not shown). Particularly, the horizontal portion 22 has a symmetric shape, and the right vertical portion 23 is symmetric to the left vertical portion 24 with respect to the symmetric axis.

Referring again to FIG. 4B, an upper opening 26 and a lower opening 27 are defined in the multipurpose bracket 2. Particularly, the upper opening 26 is defined or surrounded by the lower edge 22b of the horizontal portion 22, the right-upper protrusion 231 of the right vertical portion 23, and the left-upper protrusion 241 of the left vertical portion 24. The lower opening 27 is defined or surrounded by the right-upper protrusion 231 and right-lower protrusion 232 of the right vertical portion 23, and the left-upper protrusion 241 and the left-lower protrusion 242 of the left vertical portion 24. Moreover, the upper opening 26 is continuous with the lower opening 27, which means the two openings are connected with each other and thus can be regarded as a single larger opening. The upper opening 26 and the lower opening 27 have different shapes.

The shape of the multipurpose bracket 2 is designed to fit different shapes of different springs, especially standard, regular, or common types of springs that can be found on the market. The novel design of the multipurpose bracket 2 of the present invention allows a customer to install a lamp body onto a lamp housing without suffering the problem of incompatibility.

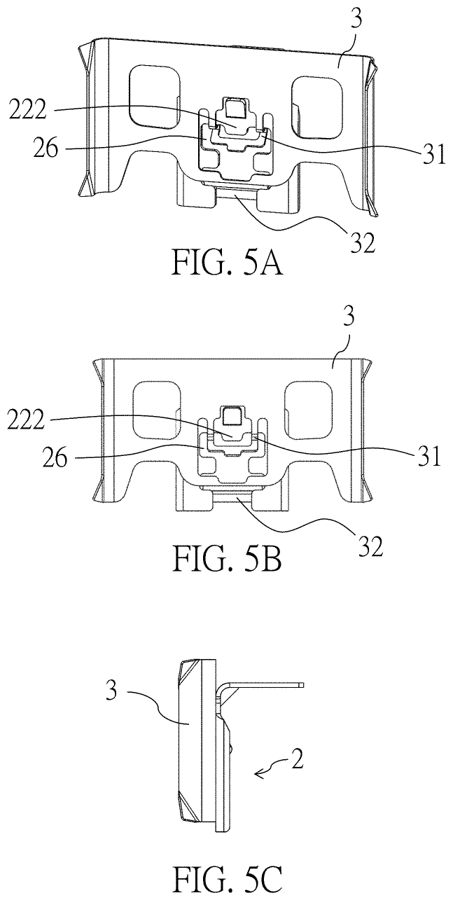

FIGS. 5A, 5B, and 5C respectively show a perspective view, a front view, and a side view of the multipurpose bracket 2 coupled with a first type of spring according to one embodiment of the present invention. The first type of spring is a leaf spring 3 for example.

As shown, the downward protrusion 222 of the horizontal portion 22, the upper opening 26, and the lower opening 27 are adapted to be coupled with a leaf spring 3. In particular, the leaf spring 3 may have a first tongue 31 to be inserted into the upper opening 26, and a hole into which the downward protrusion 222 of the horizontal portion 22 is to be inserted. Additionally, the leaf spring 3 may have a second tongue 32 to be inserted into the lower opening 27.

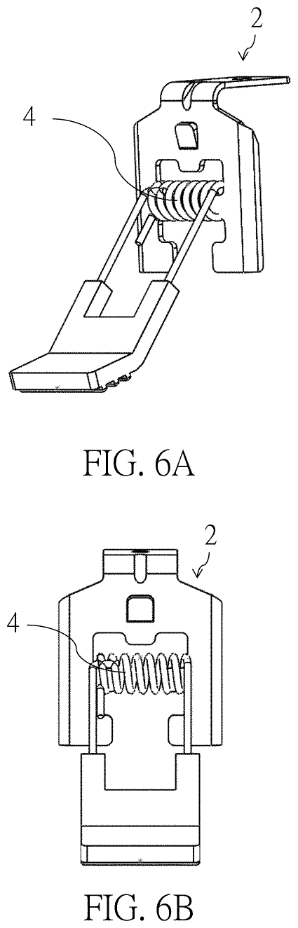

FIGS. 6A and 6B respectively show a perspective view and a front view of the multipurpose bracket 2 coupled with a second type of spring according to one embodiment of the present invention. The second type of spring is a torsion spring 4 for example.

Referring to FIG. 4A at first, the right-upper protrusion 231 of the right vertical portion 23 faces toward the left-upper protrusion 241 of the left vertical portion 24. In other words, they are horizontally aligned, but do not contact each other. Then, referring to FIGS. 6A and 6B, the two protrusions are coupled with the torsion spring 4.

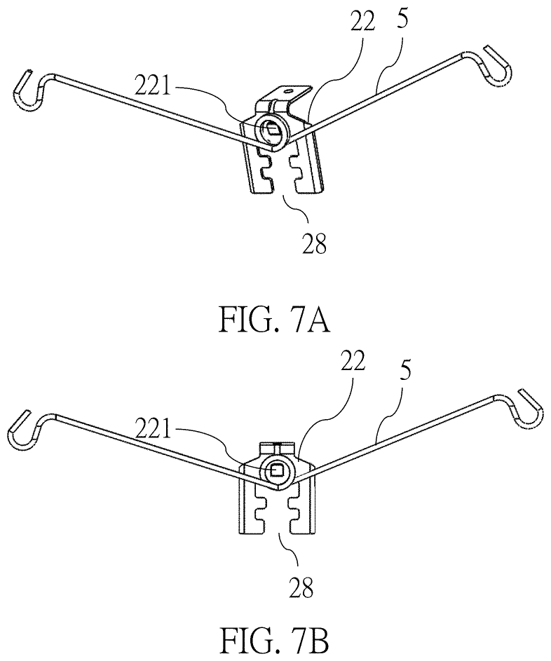

FIGS. 7A and 7B respectively show a perspective view and a front view of the multipurpose bracket 2 coupled with a third type of spring according to one embodiment of the present invention. The third type of spring is a clip spring 5 for example.

As shown, the hook 221 of the horizontal portion 22 is coupled with the clip spring 5. During assembling, a user may move the clip spring 5 from a lowest opening 28, passing through the lower opening 27 and upper opening 26, to reach the hook 221.

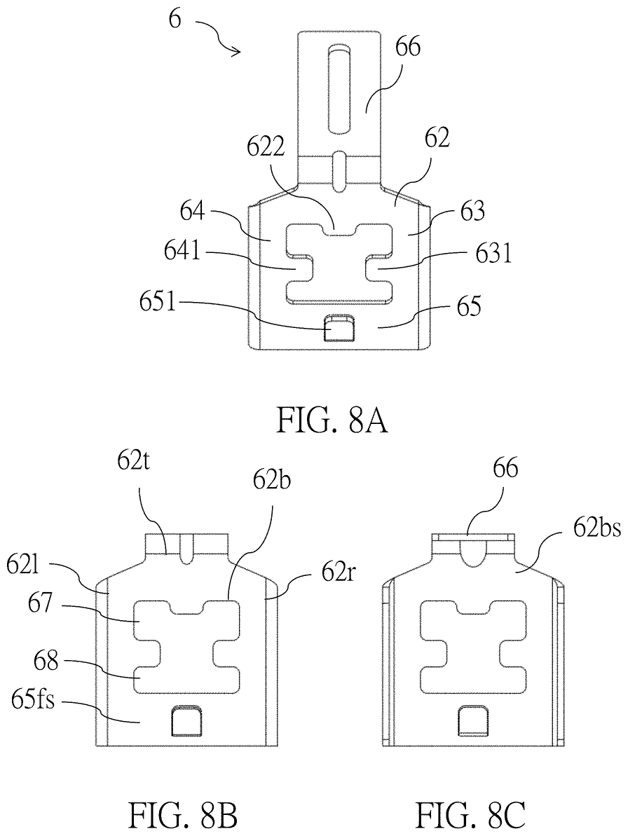

FIGS. 8A, 8B, 8C, and 8D respectively show a perspective view, a front view, a back view, and a side view of the multipurpose bracket 6 according to one embodiment of the present invention.

Referring together to FIGS. 8A, 8B, 8C, and 8D, the multipurpose bracket 6 includes an upper horizontal portion 62, a right vertical portion 63, and a left vertical portion 64.

The upper horizontal portion 62 has a downward protrusion 622 at a lower edge 62b of the upper horizontal portion 62.

The right vertical portion 63 is connected at a right end 62r of the horizontal portion 62, and has a right protrusion 631.

The left vertical portion 64 is connected at a left end 621 of the horizontal portion 62, and has a left protrusion 641.

The lower horizontal portion 65 is connected with the right vertical portion 63 at the right end of the lower horizontal portion 65, and the left vertical portion 64 at the left end of the lower horizontal portion 65, and has a hook 651 on a front surface 65fs of the lower horizontal portion 65.

Even though the multipurpose bracket 6 may be attached to the lamp body 7 shown in FIG. 3 in any suitable way, such as an adhesive or a fastener, however, for more convenience, the multipurpose bracket may include an insert 66 connected at an upper edge 62t of the upper horizontal portion 62. Moreover, the insert 66 may be bended toward a back surface 62bs of the upper horizontal portion 62.

Preferably, the upper horizontal portion 62, the right vertical portion 63, the left vertical portion 64, the lower horizontal portion 65, and the insert 66 may be formed integrally, by casting, forging, stamping, or any other suitable metalworking, so that the multipurpose bracket 6 may have a stronger structure.

As shown in FIG. 8A, the multipurpose bracket 6 is symmetric along a symmetric axis (not shown). Particularly, the upper horizontal portion 62 has a symmetric shape, and the right vertical portion 63 is symmetric to the left vertical portion 64 with respect to the symmetric axis.

Referring again to FIG. 8B, an upper opening 67 and a lower opening 68 are defined in the multipurpose bracket 6. Particularly, the upper opening 67 is defined or surrounded by the lower edge 62b of the upper horizontal portion 62, the right protrusion 631 of the right vertical portion 63, and the left protrusion 641 of the left vertical portion 64. The lower opening 68 is defined or surrounded by the right protrusion 631 of the right vertical portion 63, the left protrusion 641 of the left vertical portion 64, and an upper edge 65u of the lower horizontal portion 65. Moreover, the upper opening 67 is continuous with the lower opening 68, which means the two openings are connected with each other and thus can be regarded as a single larger opening. The upper opening 67 and the lower opening 68 have different shapes.

The shape of the multipurpose bracket 6 is designed to fit different shapes of different springs, especially standard, regular, or common types of springs that can be found on the market. The novel design of the multipurpose bracket 6 of the present invention allows a customer to install a lamp body onto a lamp housing without suffering the problem of incompatibility.

For one example, the upper protrusion 622 of the upper horizontal portion 62 and the upper opening 68 are adapted to be coupled with a leaf spring 3. The coupling is similar and may be referred to the case of FIGS. 5A, 5B, and 5C.

For another example, the right protrusion 631 of the right vertical portion 63 faces toward the left protrusion 641 of the left vertical portion 64. In other words, they are horizontally aligned, but do not contact each other. They are adapted to be coupled with a torsion spring 4. The coupling is similar and may be referred to the case of FIGS. 6A and 6B.

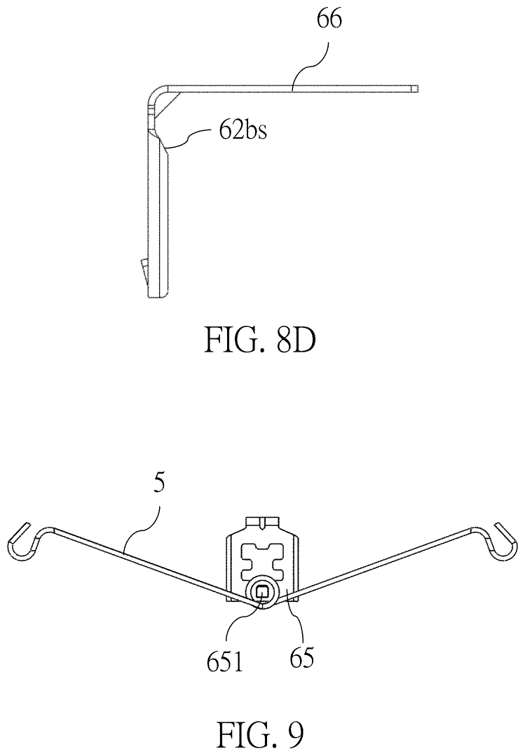

FIG.9 shows a front view of the multipurpose bracket 6 coupled with a clip spring 5 according to one embodiment of the present invention.

As shown the hook 651 of the lower horizontal portion 65 is coupled with the clip spring 5. Comparing the case of FIG. 9 with the case of FIGS. 7A and 7B, it is noted that the hook 651 is relatively near an outer edge of the multipurpose bracket 6, so that it is easier to couple the clip spring 5 to the hook 651.

Although the present invention has been explained in relation to its embodiment, it is to be understood that many other possible modifications and variations can be made without departing from the spirit and scope of the invention as hereinafter claimed.

What is claimed is:

1. A multipurpose bracket, comprising:
a horizontal portion having a hook on a front surface of the horizontal portion, and a downward protrusion at a lower edge of the horizontal portion;
a right vertical portion connected at a right end of the horizontal portion, and having a right-upper protrusion and a right-lower protrusion; and
a left vertical portion connected at a left end of the horizontal portion, and having a left-upper protrusion and a left-lower protrusion.

2. The multipurpose bracket of claim 1, further comprising an insert connected at an upper edge of the horizontal portion.

3. The multipurpose bracket of claim 2, wherein the insert is bended toward a back surface of the horizontal portion.

4. The multipurpose bracket of claim 2, wherein the horizontal portion, the right vertical portion, the left vertical portion, and the insert are formed integrally.

5. The multipurpose bracket of claim 1, wherein the horizontal portion has a symmetric shape, and the right vertical portion is symmetric to the left vertical portion.

6. The multipurpose bracket of claim 1, further comprising:
an upper opening defined by the lower edge of the horizontal portion, the right-upper protrusion of the right vertical portion, and the left-upper protrusion of the left vertical portion; and
a lower opening defined by the right-upper protrusion and right-lower protrusion of the right vertical portion, and the left-upper protrusion and the left-lower protrusion of the left vertical portion;
wherein the upper opening is continuous with the lower opening.

7. The multipurpose bracket of claim 6, wherein the upper opening and the lower opening have different shapes.

8. The multipurpose bracket of claim 6, wherein the downward protrusion of the horizontal portion and the upper opening are adapted to be coupled with a leaf spring.

9. The multipurpose bracket of claim 1, wherein the right-upper protrusion of the right vertical portion faces toward the left-upper protrusion of the left vertical portion, and they are adapted to be coupled with a torsion spring.

10. The multipurpose bracket of claim 1, wherein the hook of the horizontal portion is adapted to be coupled with a clip spring.

11. A multipurpose bracket, comprising:
an upper horizontal portion having a downward protrusion at a lower edge of the upper horizontal portion;
a right vertical portion connected at a right end of the horizontal portion, and having a right protrusion;
a left vertical portion connected at a left end of the horizontal portion, and having a left protrusion; and
a lower horizontal portion connected with the right vertical portion and the left vertical portion, and having a hook on a front surface of the lower horizontal portion.

12. The multipurpose bracket of claim 11, further comprising an insert connected at an upper edge of the upper horizontal portion.

13. The multipurpose bracket of claim 12, wherein the insert is bended toward a back surface of the upper horizontal portion.

14. The multipurpose bracket of claim 12, wherein the upper horizontal portion, the right vertical portion, the left vertical portion, the lower horizontal portion, and the insert are formed integrally.

15. The multipurpose bracket of claim 11, wherein the upper horizontal portion has a symmetric shape, and the right vertical portion is symmetric to the left vertical portion.

16. The multipurpose bracket of claim 11, further comprising:
an upper opening defined by the lower edge of the upper horizontal portion, the right protrusion of the right vertical portion, and the left protrusion of the left vertical portion; and
a lower opening defined by the right protrusion of the right vertical portion, the left protrusion of the left vertical portion, and an upper edge of the lower horizontal portion;
wherein the upper opening is continuous with the lower opening.

17. The multipurpose bracket of claim 16, wherein the upper opening and the lower opening have different shapes.

18. The multipurpose bracket of claim 16, wherein the upper protrusion of the upper horizontal portion and the upper opening are adapted to be coupled with a leaf spring.

19. The multipurpose bracket of claim 11, wherein the right protrusion of the right vertical portion faces toward the left protrusion of the left vertical portion, and they are adapted to be coupled with a torsion spring.

20. The multipurpose bracket of claim 11, wherein the hook of the lower horizontal portion is adapted to be coupled with a clip spring.
